(19) United States
(12) Patent Application Publication
(10) Pub. No.: US 2018/0057217 A1
(43) Pub. Date: Mar. 1, 2018

(54) Slit-Score Security Paper Shopping Bag

(71) Applicant: John T Veder, Lagrange, KY (US)

(72) Inventor: John T Veder, Lagrange, KY (US)

(21) Appl. No.: 15/253,726

(22) Filed: Aug. 31, 2016

(51) Int. Cl. B65D 33/10; B65D 30/20; B65D 33/18; B31B 1/86; B31B 29/74

(52) U.S. Cl. CPC B65D 33/105; B65D 31/10; B31B 29/74; B31B 1/86; B65D 33/18

(57) ABSTRACT

Bags having handles a closeable top and methods for making such bags are disclosed.

### BACKGROUND

Many commercial establishments, such as retail stores, as well as consumers use bags for transporting articles such as groceries and other items. The present invention is directed to inventive bags and methods for making the same.

### SUMMARY OF THE INVENTION

In some embodiments, the invention includes bags having a top, two exterior faces, a bottom, and two sides. The bags may also include a horizontal score line, which may be located within a range from about 0.5 inches to about 2.5 inches from the top and extending horizontally around the bag, and a horizontal slit is on each exterior face. Each horizontal slit may be located about 3 inches to about 6 inches down from the top and may be about 3 inches wide to about 6 inches wide. The bags may also include handles that extend through each horizontal slit such that the handles are secured on the interior of the bag but extend from the horizontal slits to the exterior of the bag. The bags may be securely closed by folding the top of the bag along the horizontal score line and tucking the top behind a handle of the bag. The present invention also includes methods of making bags.

### BRIEF DESCRIPTION OF THE DRAWINGS

These and other features, aspects, and advantages of the present invention are better understood when the following detailed description is read with reference to the accompanying drawings, wherein:

FIGS. 1A-1D depict an intermediate product in the manufacture of bags pursuant to some embodiments of the present invention, wherein each figure is a partial view of the intermediate product and these figures may be joined from left to right in the order of FIG. 1A-1D to depict the entire intermediate product (and wherein FIGS. 1A-1D are collectively referred to as FIG. 1 herein);

FIG. 2 is a partial view of a bag having handles and with the top of the bag in an open configuration;

FIG. 3A illustrates an embodiment of a bag of the present invention, which is illustrated with the top in an open configuration;

FIG. 3B illustrates the bag of FIG. 3A with the top in a closed configuration;

FIG. 4 illustrates a partial view of an embodiment of a bag of the present invention, which is illustrated with the top in an closed configuration;

FIG. 5 illustrates an embodiment of the bag of the present invention in a closed configuration.

### DETAILED DESCRIPTION OF EXEMPLARY EMBODIMENTS

Reference will now be made in detail to various embodiments of the invention, one or more examples of which are illustrated in the accompanying drawings. Each example is provided by way of explanation, not limitation, of the invention. In fact, it will be apparent to those skilled in the art that modifications and variations can be made in the present invention without departing from the scope and spirit thereof. For instance, features illustrated or described as part of one embodiment may be used on another embodiment to yield a still further embodiment. Thus, it is intended that the present invention covers such modifications and variations as come within the scope of the appended claims and their equivalents.

The use of reference characters with the same two ending digits as other reference characters to indicate structure in the present specification and drawings, without a specific discussion of such structure, is intended to represent the same or analogous structure in different embodiments.

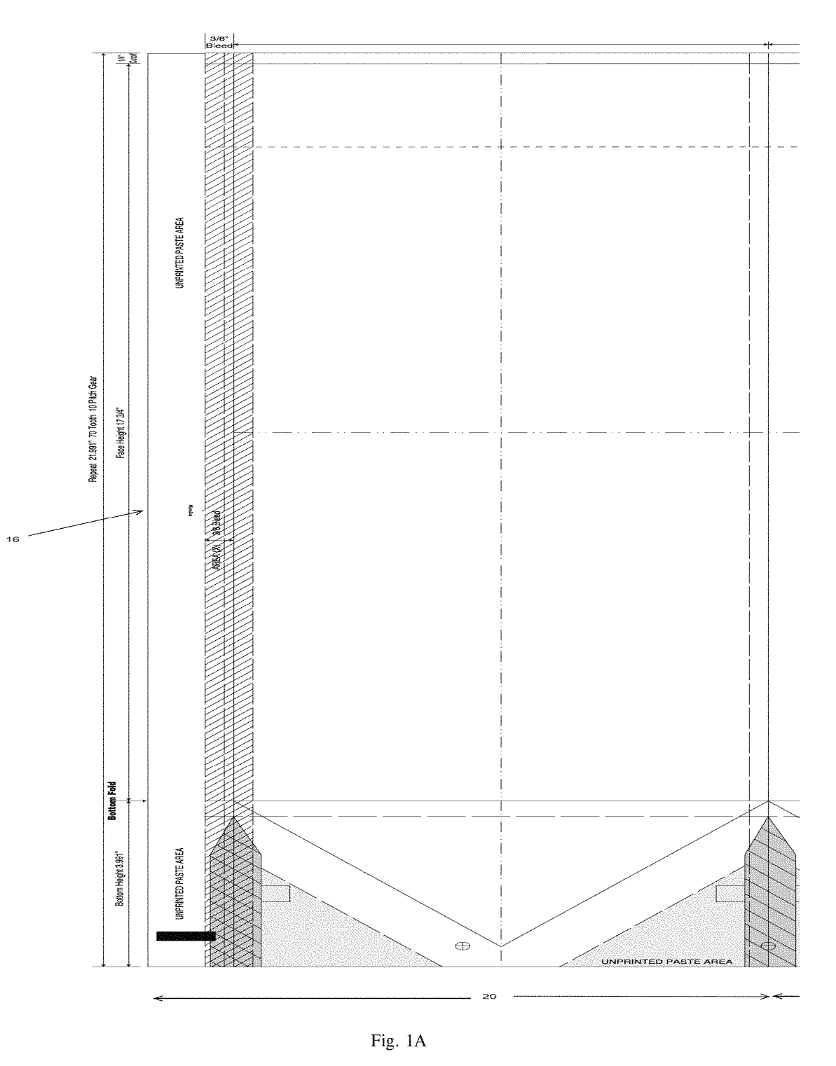

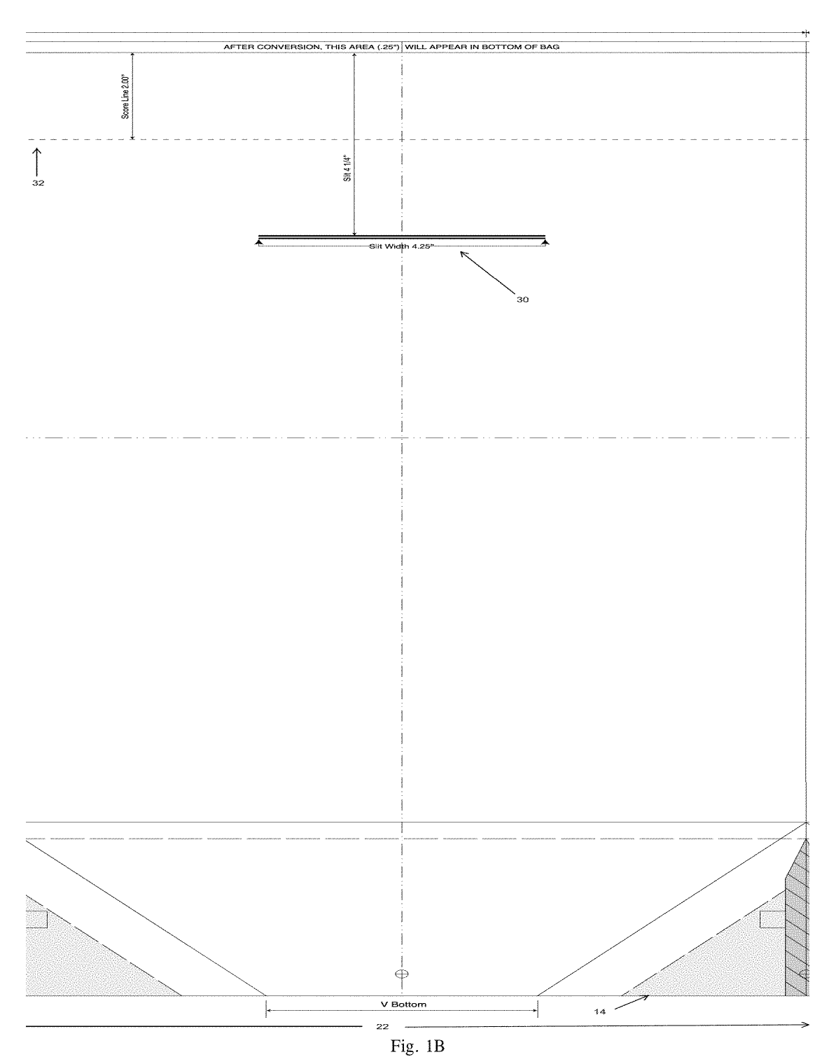

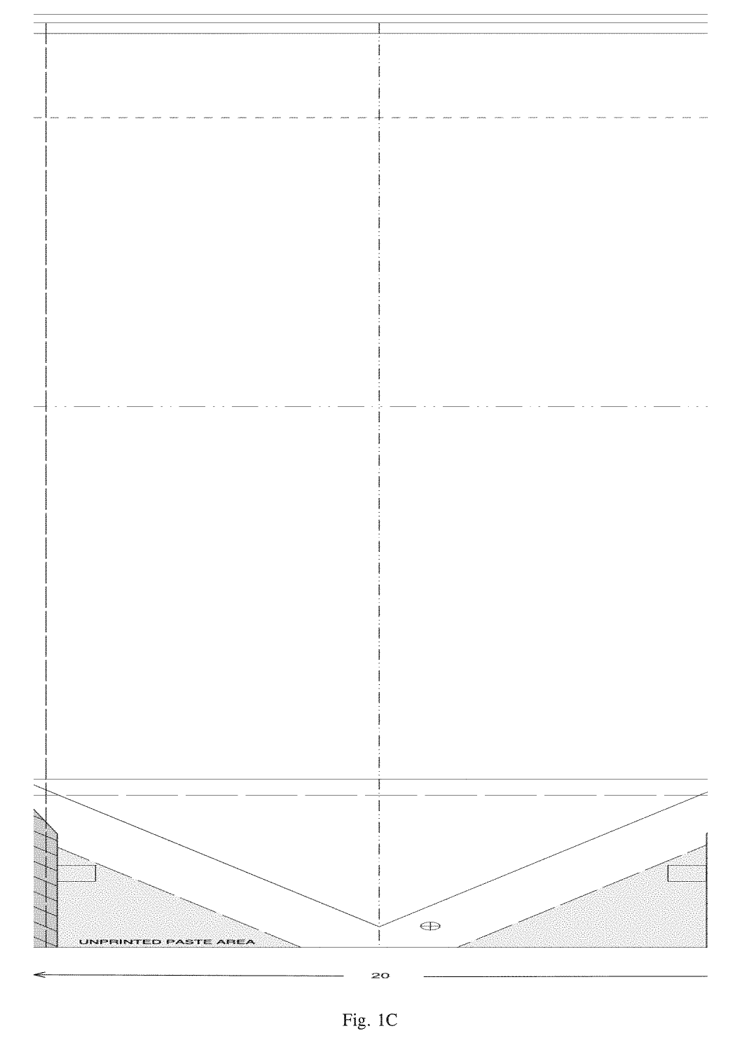

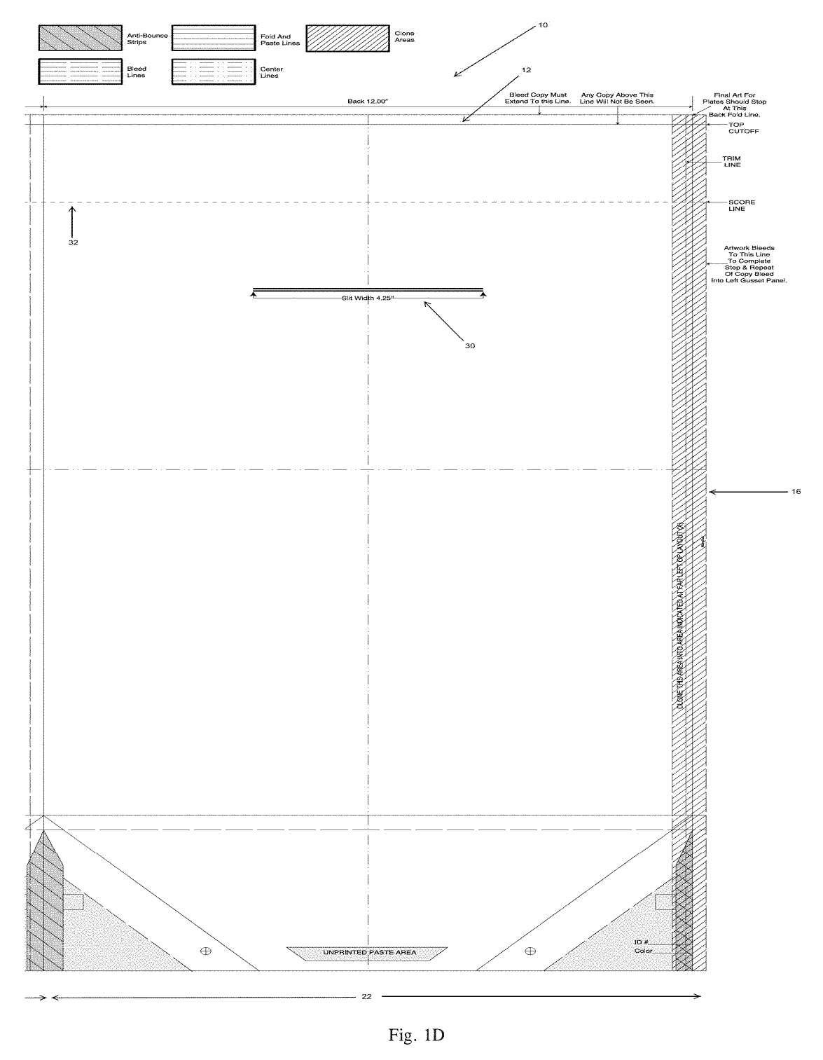

In some embodiments, the invention includes a square bottom paper bag that includes a slit-score feature and a method for making such a bag. In one such embodiment for making such bags, a horizontal slit is introduced in the bag while still in a tube on a bag machine (i.e., before bottom forming is commenced). For example, FIGS. 1A-1D (collectively referenced as FIG. 1 herein) illustrate an exemplary embodiment of a tube of paper 10, which is an intermediate product in the production of a paper bag prior to forming the bottom of that resulting bag. Tube of paper 10, which is in flat arrangement, has a top 12 (also called the bag cutoff), bottom 14, and sides 16. In addition, tube of paper has side portions 20, which will be a side portion of the resulting bag, and face portions 22, which will form front and rear portions of the resulting bag. Side portions 20 may also be designed to form a gusset in the resulting bag, as shown in FIG. 1.

As shown in FIG. 1, horizontal slits 30 are formed in face portions 22 of the tube of paper 10. In some embodiments, such horizontal slits may be about 4.25 inches wide and centered left to right. In other embodiments, the horizontal slit may be from about 3 inches wide to about 6 inches wide, including each intermittent value therein. In some embodiments, each face portion 22 may have multiple horizontal slits. For example, in another embodiment not shown, each slit 30 shown in FIG. 1 could be divided into two slits with a non-slit portion separating them. In addition, as also shown in FIG. 1, the horizontal slit may be positioned about 4.25 inches down from the top 12, which is also the bag cutoff at which another bag will be formed. In still other embodiments, horizontals 30 slit may be positioned from about 3 inches wide to about 6 inches down from the top 12, including each intermittent value therein.

As shown in FIG. 1, a horizontal score line 32 may be formed in tube of paper 10. In some embodiments, horizontal score line 32 has a width equivalent, or approximately equivalent, to the width of the particular bag. The score line may be positioned below top 12 of tube of paper 10. As shown in FIG. 1, the score line is positioned approximately 2 inches below form the cutoff. In other embodiments, the score line may be positioned in any area above the horizontal slit. For example, in some embodiments, horizontal score line may be positioned from 0.5 inches to about 2.5 inches below the top 12, including each intermittent value therein. In some embodiments, the horizontal score line may be positioned at least at or above the midpoint between the horizontal slit and the top 12. In some embodiments, sides 16 of tube of paper 10 may be adjoined and bottom formation of the resulting bag from tube of paper 10 may be completed using any conventional manner, such as using an adhesive, after the aforementioned features are introduced into tube of paper 10, thereby forming a bag blank. Additional fold lines may also be included in the tube of paper 10 to allow for folding of the paper bag or its bottom for shipping and storage purposes.

In some embodiments, the horizontal score line may be formed approximately half the distance between the top of what will result in form the top of the bag, as discussed below, and the horizontal slit. In other embodiments, the horizontal score line may be formed above the horizontal slit at a location that is at approximately equidistant between the horizontal slit and the top of what will result in form the top of the bag, as discussed below, or that is at a location that is closer to the top of the bag, as discussed below, than the horizontal slit.

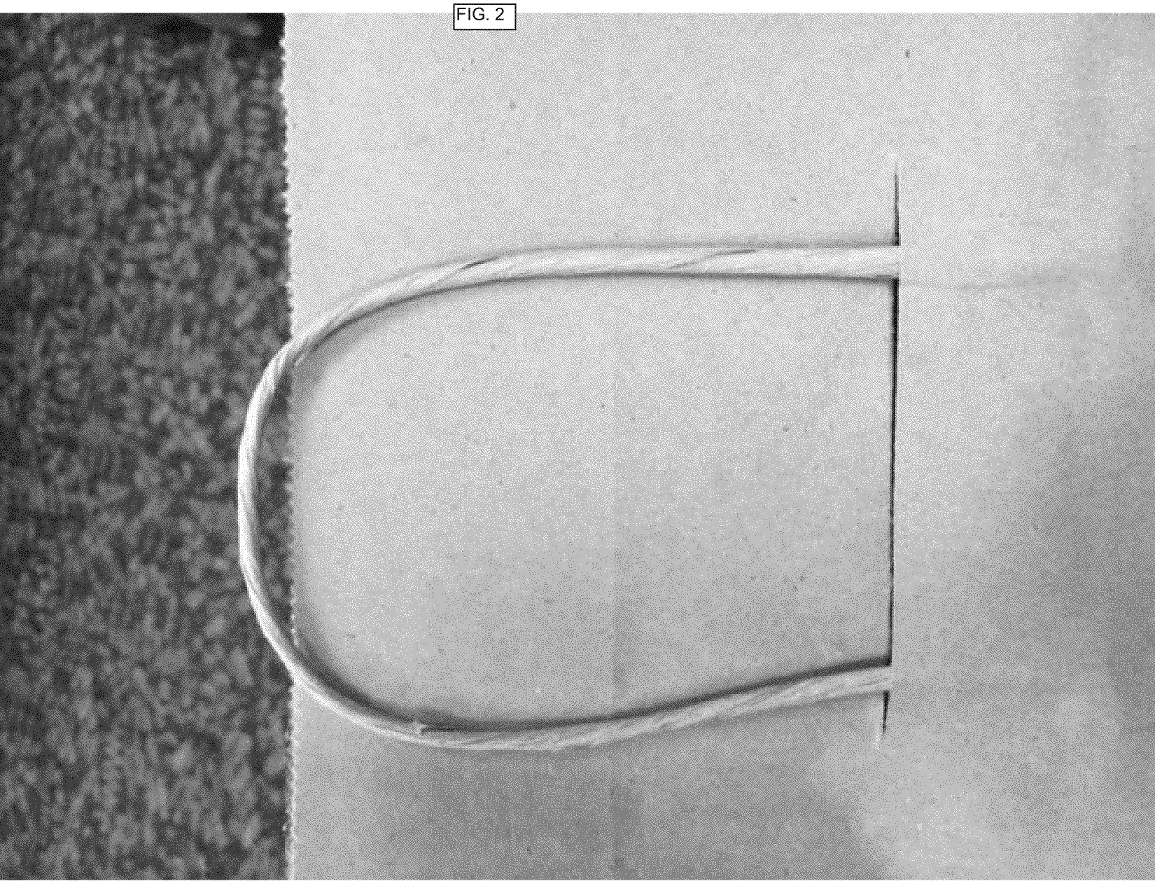

From the process described above, a bag is produced without handles. Handles may then be affixed to the bag blanks. In some embodiments, paper twisted handles 34 (as shown in FIG. 2, which may be affixed to a paper/board patch 36, may inserted (either manually or in an automated manner) from the inside of the bag up through a horizontal slit 30. As a result, the paper/board patch 36 remains on the interior of the resulting bag and handles 34 extend to the exterior of the bag. The patch 36 may be secured to the interior of the bag, such as by adhesive, tape, or any other suitable means. In alternative embodiments, handles may be inserted through horizontal slot in any manner and then joined to a patch. In some embodiments, a patch may be omitted and the ends of handles joined together after being inserted through the horizontal slit or being adhered directly to the bag.

In some embodiments, each bag may have two handles, wherein one handle is present in each horizontal slit 30. In other embodiments, a bag may have greater than two handles with multiple handles extending through each horizontal slit 30. In still other embodiments, a bag may have multiple horizontal slits on each face of the bag with one or more handles extending through each horizontal slit. FIG. 2 illustrates a handle 34 that has been inserted through a horizontal slit 30.

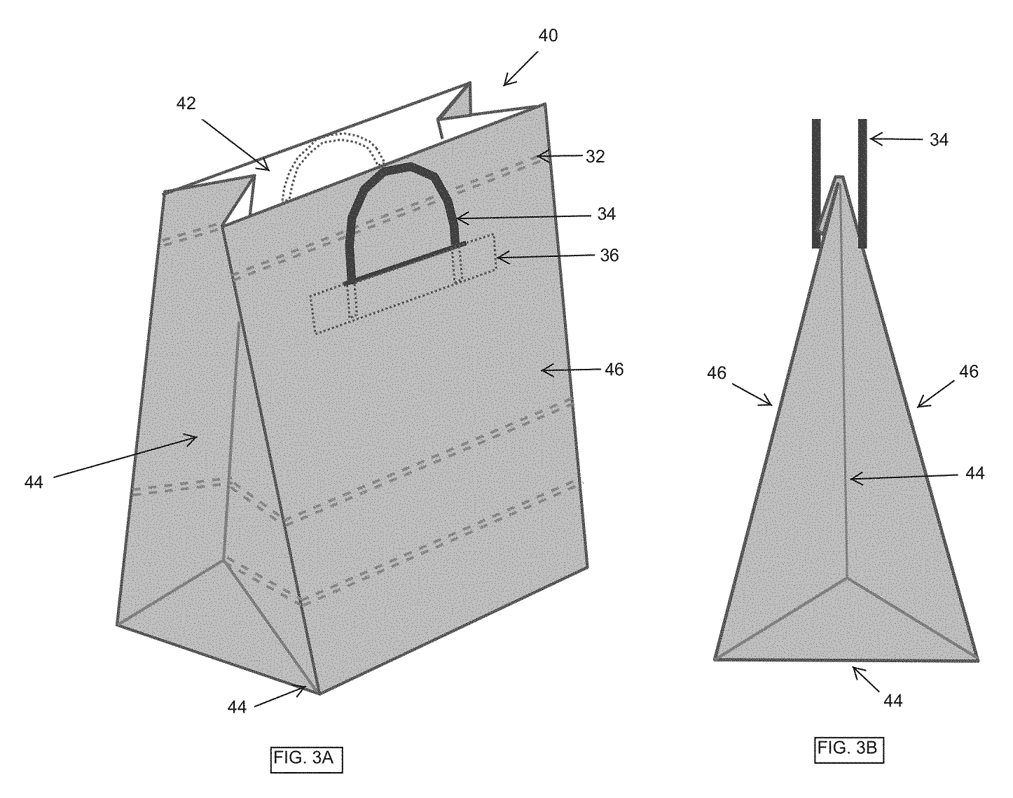

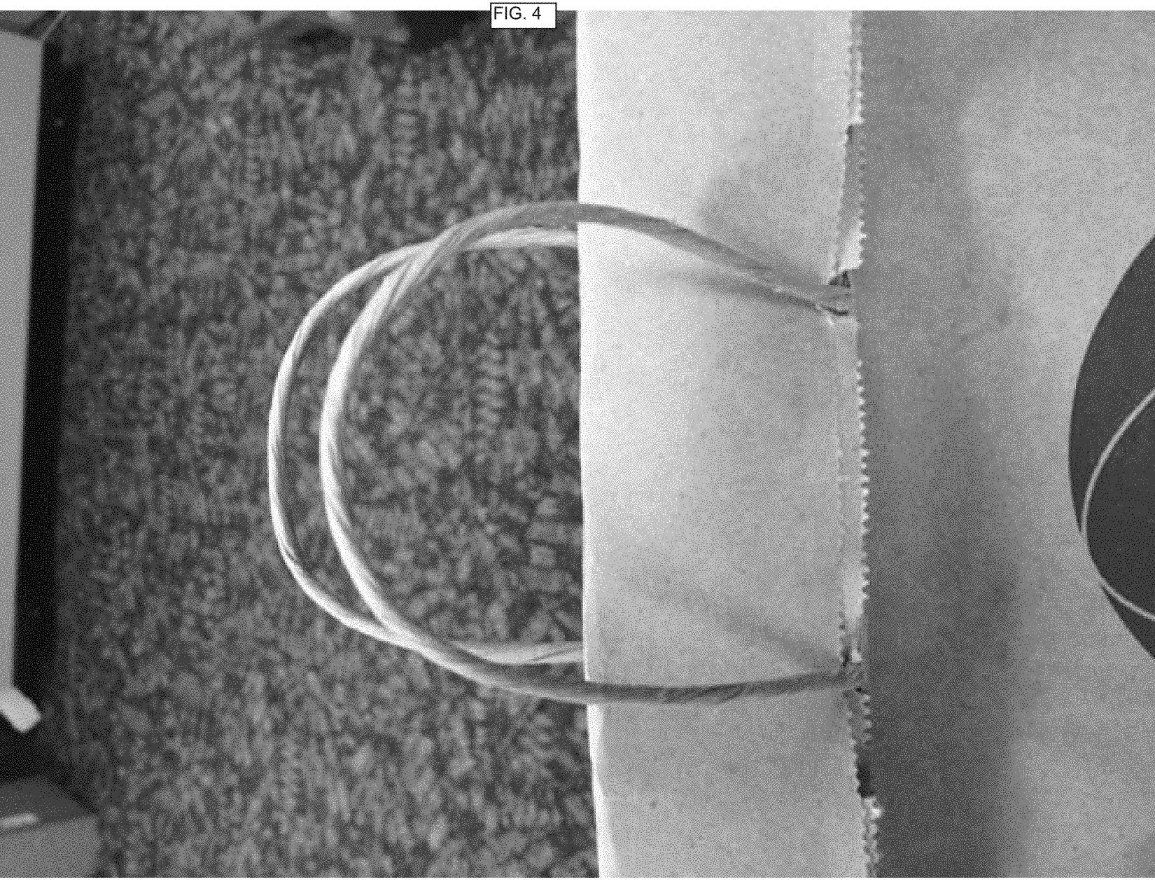

On exemplary embodiment of a bag of the present invention is depicted in FIG. 3A, which resulted from the tube of paper 10 described above. As shown, bag 40 includes top 42, bottom 43, gusseted sides 44, and faces 46. Bag 40 also includes horizontal score line 32, handles 34 and paper/board patches 36, which are located on the interior of the bag.

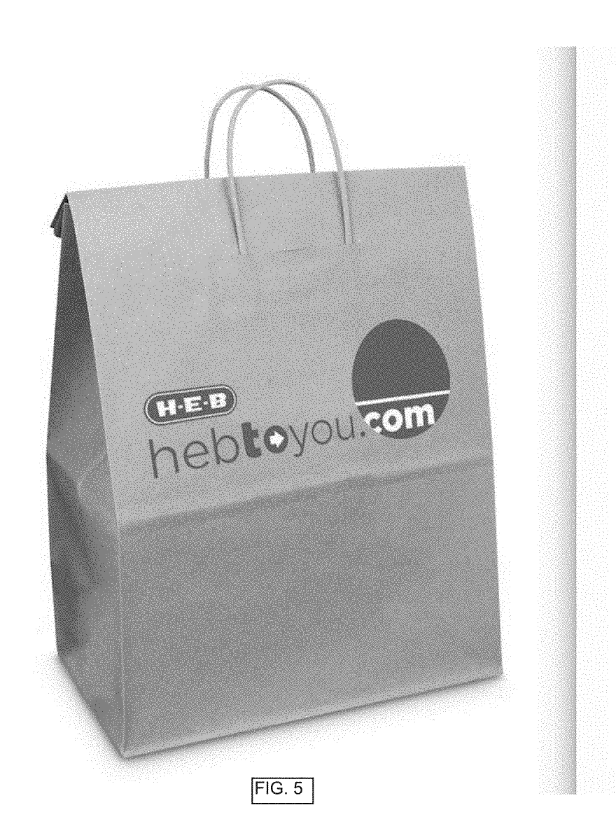

Bags of the present invention, such as shown in the illustrative embodiment of FIG. 3A, may be loaded with any suitable contents. After loading, top 42 of bag 10 may be folded down and creased at the horizontal score line 32. Upon such folding, the folded top portion may be position behind handle 42 on one face 46 of bag 40 as shown in FIG. 3B and FIG. 4. This feature provides a locking or sealing feature for the closed bag such that the folded top remains closed, such as shown in FIG. 3B and FIG. 4. Tape (including tamper-evident tape), adhesive, staples, or other sealing means may optionally be used to seal the folded top portion to the face of bag 40, but the positioning of the flap behind a handle also serves to retain the bag in a closed configuration without additional sealing means.

In some embodiments, it is essential that the handles are positioned on the exterior portion of the bag. Such positioning permits the top portion of the bags to be folded over and tucked behind the handles, which is in furtherance of such embodiments of the invention. As such, as described below, the bags of such embodiments may be closed entirely without any holes being required in the top portion of the bag to accommodate the handles when folding the top portion over.

Bags of the present invention may be made of any suitable materials. In some embodiments, the bags are papers bags. Paper bags may be made from different types of materials, including, without limitation, brown kraft, clay coat, laminated materials, white kraft, and recycled paper, other materials, and combinations thereof. In other embodiments, alternative or additional materials may be used, such as polymeric materials, including, without limitation, polymeric materials, including polyolefins. For example, polymers may include polyethylenes such as linear low density polyethylene (LLDPE), low density polyethylene (LDPE), high density polyethylene (HDPE), high molecular weight high density polyethylene (HMW-HDPE), and combinations thereof.

Bags of the present invention may be made by any suitable process subject to the features described herein. For example, the general features of a bag, excluding the handles, may be formed by any bag-making process as modified for the inventive features herein, such as by, without limitation, the process disclosed in U.S. Pat. No. 8,764,618, which is incorporated herein in its entirety by reference thereto. Similarly, the process disclosed in U.S. Pat. No. 5,458,556, which also is incorporated herein in its entirety by reference thereto, may be used as modified by the present disclosure for making bags of the present invention.

The foregoing description of illustrative embodiments of the invention has been presented only for the purpose of illustration and description and is not intended to be exhaustive or to limit the invention to the precise forms disclosed. Numerous modifications and adaptations thereof will be apparent to those of ordinary skill in the art without departing from the scope of the present invention.

It will be understood that each of the elements described above, or two or more together, may also find utility in applications differing from the types described. While the invention has been illustrated and described in the general context of mixing in wastewater treatment systems and processes, it is not intended to be limited to the details shown since various modifications and substitutions can be made without departing in any way from the spirit and scope of the present invention. As such, further modifications and equivalents of the invention herein disclosed may occur to persons skilled in the art using no more than routine experimentation, and all such modifications and equivalents are believed to be within the spirit and scope of the invention as described herein.

What is claimed is:

1. A bag comprising:
a top,
two exterior faces,
a bottom, and
two sides,
a horizontal score line located within a range from about 0.5 inches to about 2.5 inches from the top and extending horizontally around the bag,
a horizontal slit is on each exterior face, wherein the horizontal slit is located about 3 inches to about 6 inches down from the top and is about 3 inches wide to about 6 inches wide,
and handles that extend through each horizontal slit such that the handles are secured on the interior of the bag but extend from the horizontal slits to the exterior of the bag.

2. The bag of claim 1 wherein the horizontal score line is located about 2 inches from the top.

3. The bag of claim 1 wherein the horizontal slits are located about 4.25 inches from the top and are about 4.25 inches wide.

4. The bag of claim 1 wherein the top is folded about the score line such that the top is located behind a handle of the bag to form a closed bag.

5. The bag of claim 1 wherein the bag comprises brown kraft, clay coat, laminated materials, white kraft, recycled paper, or combinations thereof

6. A method for making a bag, the method comprising:
providing a flat paper having a top, sides, and a bottom,
forming a horizontal score line in the paper within a range from about 0.5 inches to about 2.5 inches from the top and extending the width of the paper,
forming at least two horizontal slits located about 3 inches to about 6 inches down from the top and is about 3 inches wide to about 6 inches wide, wherein each horizontal slit is located in a portion of the flat paper that will form the face of a resulting bag,
joining the sides of the flat paper and forming a bottom of the bag,
inserting handles having a patch through each horizontal slit, wherein the patch remains on the interior of the bag and the handles extend through the horizontal slits to the exterior of the bag, and
securing the patch to the interior of the bag.
